(19) United States
(12) Patent Application Publication
(10) Pub. No.: US 2023/0061230 A1
(43) Pub. Date: Mar. 2, 2023

(54) METHOD AND SYSTEM FOR DETECTING AN ABNORMAL OCCURRENCE OF AN APPLICATION PROGRAM

(71) Applicant: FAR EASTONE TELECOMMUNICATIONS CO., LTD., Taipei City (TW)

(72) Inventors: Wei Chih YEH, New Taipei City (TW); Kuo Ching CHENG, New Taipei City (TW); Heng Ping TSAI, New Taipei City (TW)

(21) Appl. No.: 17/848,794

(22) Filed: Jun. 24, 2022

(30) Foreign Application Priority Data
Sep. 2, 2021 (TW) 110132624

(51) Int. Cl. G06F 11/07; G06F 11/34; G06N 20/20

(52) U.S. Cl. CPC G06F 11/0781; G06F 11/3476; G06N 20/20

(57) ABSTRACT

A method for detecting an abnormal occurrence of an application program includes a feature parameter collected according to the log data of at least one application program. The feature parameter is inputted into a first and a second prediction model and a first and a second detection model, and the feature parameter is calculated based on the first and the second prediction model and the first and the second detection model to respectively generate a first and a second prediction value and a first and a second detection value. The first and the second prediction value and the first and the second detection value are respectively weighted based on an abnormal score evaluation equation to generate an abnormal evaluation value of the application program. Finally, the abnormal evaluation value is inputted into a warning ranking model to rank the abnormal evaluation value, generating the corresponding warning signal.

This application claims priority of Application No. 110132624 filed in Taiwan on 2 Sep. 2021 under 35 U.S.C. § 119; the entire contents of all of which are hereby incorporated by reference.

### BACKGROUND OF THE INVENTION

### Field of the Invention

The present invention relates to a technology for processing electronic digital data, particularly to a method and a system for detecting an abnormal occurrence of an application program and predicting the abnormal trend of the application program.

### Description of the Related Art

With the rapid development of network technology, cloud management technology is relatively widely used. Generally speaking, when the receptionist of the enterprise confirms the transaction content with the customer and generates an order form, the receptionist has access to the application program installed in the cloud server through the network, and then inputs and stores the customer's order data in the cloud database.

Take a telecommunications company as an example. When operating the application program to make an order form, the receptionist needs to perform many confirmation steps, such as inputting customer information, checking customer qualifications, confirming promotion plans, confirming product models, and confirming the steps of adding value and checkout.

However, when the receptionist operates the application program and there is a problem in any of the steps handled, the overall business management of the company will be affected and the customer may also spend time waiting for the error to be eliminated before completing the transaction. Thus, this case results in poor service perception.

Therefore, if we can predict the occurrence of possible problems in the operation of the application program in advance rather than wait for the problem to occur before checking and repairing the application program, we can reduce the waiting time of customers or receptionists to improve service efficiency and quality.

To overcome the abovementioned problems, the present invention provides a method and a system for detecting an abnormal occurrence of an application program, so as to solve the afore-mentioned problems of the prior art.

### SUMMARY OF THE INVENTION

The primary objective of the present invention provides a method and a system for detecting an abnormal occurrence of an application program, which actively predict the abnormal trend of the application program for early detection and countermeasures.

Another objective of the present invention provides a method and a system for detecting an abnormal occurrence of an application program, which actively predict the abnormal trend of the application program, and distinguish different levels of warnings according to abnormal situations, so as to effectively remind the administrator of taking countermeasures.

In an embodiment of the present invention, a method for detecting an abnormal occurrence of an application program includes: collecting a feature parameter according to log data of at least one application program; respectively inputting the feature parameter into a first prediction model, a second prediction model, a first detection model, and a second detection model, and calculating the feature parameter based on the first prediction model, the second prediction model, the first detection model, and the second detection model to respectively generate a first prediction value, a second prediction value, a first detection value, and a second detection value; respectively weighting the first prediction value, the second prediction value, the first detection value and the second detection value based on an abnormal score evaluation equation to generate an abnormal evaluation value of the at least one application program; and inputting the abnormal evaluation value into a warning ranking model to rank the abnormal evaluation value, wherein generating a first warning signal when the abnormal evaluation value is greater than a first ranking threshold and the abnormal evaluation value is less than or equal to a second ranking threshold, and generating a second warning signal when the abnormal evaluation value is greater than the second ranking threshold.

In an embodiment of the present invention, the abnormal score evaluation equation is represented with

$$\frac{{\sum }_{i = 1}^{n} {w}_{i} {x}_{i}}{n} ,$$

n=the count of x, where xᵢ represents the first prediction value, the second prediction value, the first detection value or the second detection value, and wᵢ represents the weighted value of the first prediction value, the second prediction value, the first detection value or the second detection value.

In an embodiment of the present invention, the step of respectively inputting the feature parameter into the first prediction model and the second prediction model and calculating the feature parameter based on the first prediction model, the second prediction model to respectively generate the first prediction value and the second prediction value includes: by the first prediction model and the second prediction model, receiving and calculating the feature parameter to respectively generate first predicting abnormal number and second predicting abnormal number; and comparing the first predicting abnormal number and the second predicting abnormal number with a predicting abnormal number threshold to generate results, thereby generating the first prediction value and the second prediction value.

In an embodiment of the present invention, the result indicates whether the first predicting abnormal number or the second predicting abnormal number is within the range of the predicting abnormal number threshold.

In an embodiment of the present invention, the first prediction model is a long short-term memory (LSTM) model.

In an embodiment of the present invention, the second prediction model is a Poisson regression model.

In an embodiment of the present invention, the first detection model is a HC+Decision tree model.

In an embodiment of the present invention, the second detection model is an isolation forest (iForest) model.

In an embodiment of the present invention, the feature parameter includes time information and the number of abnormal occurrences corresponding to the time information.

In an embodiment of the present invention, a system for detecting an abnormal occurrence of an application program includes a feature parameter collecting device, a processing device, and a warning device. The feature parameter collecting device is configured to collect a feature parameter according to log data of at least one application program. The processing device is coupled to the feature parameter collecting device and configured to receive the feature parameter. The processing device includes a first prediction module, a second prediction module, a first detection module, a second detection module, an abnormal score evaluation module, and a warning ranking module. The first prediction module is configured to receive and calculate the feature parameter to generate a first prediction value. The second prediction module is configured to receive and calculate the feature parameter to generate a second prediction value. The first detection module is configured to receive and calculate the feature parameter to generate a first detection value. The second detection module is configured to receive and calculate the feature parameter to generate a second detection value. The abnormal score evaluation module is configured to respectively weight the first prediction value, the second prediction value, the first detection value and the second detection value based on an abnormal score evaluation equation to generate an abnormal evaluation value of the at least one application program. The warning ranking module is configured to receive and rank the abnormal evaluation value. The warning ranking module generates a first warning signal when the abnormal evaluation value is greater than a first ranking threshold and the abnormal evaluation value is less than or equal to a second ranking threshold. The warning ranking module generates a second warning signal when the abnormal evaluation value is greater than the second ranking threshold. The warning device is coupled to the processing device and configured to receive and send out the first warning signal and the second warning signal.

In an embodiment of the present invention, the abnormal score evaluation equation is represented with

$$\frac{{\sum }_{i = 1}^{n} {w}_{i} {x}_{i}}{n} ,$$

n=the count of x, where xᵢ represents the first prediction value, the second prediction value, the first detection value or the second detection value, and wᵢ represents the weighted value of the first prediction value, the second prediction value, the first detection value or the second detection value.

In an embodiment of the present invention, the first prediction module includes a first prediction model and the second prediction module includes a second prediction model. The first prediction module and the second prediction module respectively calculate the feature parameter to generate first predicting abnormal number and second predicting abnormal number based on the first prediction model and the second prediction model. The first prediction module and the second prediction module respectively compare the first predicting abnormal number and the second predicting abnormal number with a predicting abnormal number threshold to generate results, thereby generating the first prediction value and the second prediction value.

In an embodiment of the present invention, the result indicates whether the first predicting abnormal number or the second predicting abnormal number is within the range of the predicting abnormal number threshold.

In an embodiment of the present invention, the first prediction model is a long short-term memory (LSTM) model.

In an embodiment of the present invention, the second prediction model is a Poisson regression model.

In an embodiment of the present invention, the first detection module includes a first detection model for calculating the feature parameter to generate the first detection value. The first detection model is a HC+Decision tree model.

In an embodiment of the present invention, the second detection module includes a second detection model for calculating the feature parameter to generate the second detection value. The second detection model is an isolation forest (iForest) model.

In an embodiment of the present invention, the feature parameter includes time information and the number of abnormal occurrences corresponding to the time information.

Below, the embodiments are described in detail in cooperation with the drawings to make easily understood the technical contents, characteristics and accomplishments of the present invention.

### BRIEF DESCRIPTION OF THE DRAWINGS

FIG. 1 is a schematic diagram illustrating a system for detecting an abnormal occurrence of an application program according to an embodiment of the present invention;

FIG. 2 is a flowchart of a method for detecting an abnormal occurrence of an application program according to an embodiment of the present invention; and

FIG. 3 is a flowchart of another method for detecting an abnormal occurrence of an application program according to an embodiment of the present invention.

### DETAILED DESCRIPTION OF THE INVENTION

The method and the system for detecting an abnormal occurrence of an application program of the present invention can predict the abnormal occurrences of the application program and provide corresponding warnings at different levels, so that the application program can be repaired in advance before abnormal occurrences, and the overall benefit can be effectively improved.

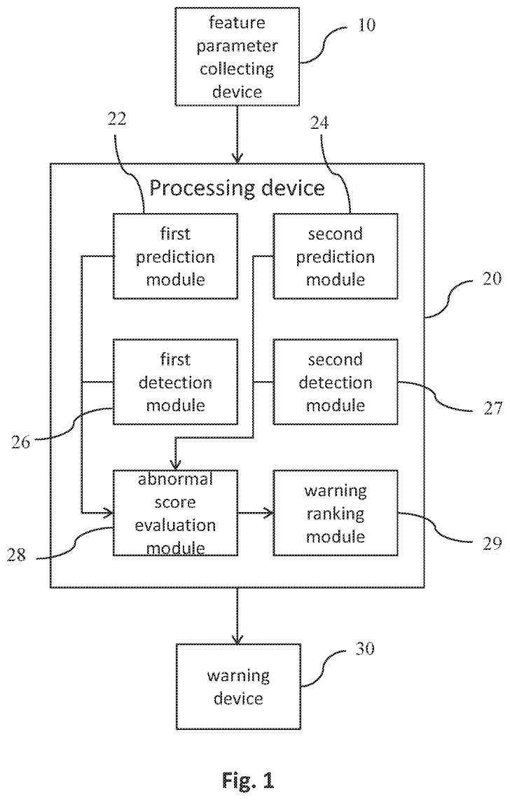

The system for detecting an abnormal occurrence of an application program of the present invention is introduced as follows. Referring to FIG. 1, the system 1 for detecting an abnormal occurrence of an application program includes a feature parameter collecting device 10, a processing device 20, and a warning device 30. The processing device 20 is coupled to the feature parameter collecting device 10 and the warning device 30. The feature parameter collecting device 10 may be a receiving device, such as a network transceiver or a signal connector. The feature parameter collecting device 10 has access to the application program through the network and collects a feature parameter of the application program according to log data of the application program. Alternatively, the feature parameter collecting device 10 connects to a hard disk through the signal connector and has access to the feature parameter stored in the hard disk. The feature parameter includes time information and the number of abnormal occurrences corresponding to the time information. For example, the feature parameter may be the number of abnormal occurrences of the application program within a fixed period of time, such as working hours, holiday periods, one year, one month, one hour, one minute, day of the week, working day, day, night, time before business, etc.

The processing device 20 is an operation device, such as a central processing unit (CPU). The processing device 20 receives and calculates the feature parameter. The processing device 20 calculates the collected feature parameter using a neural network technology. In other words, according to the past time, the processing device 20 can predict the abnormal occurrence at the corresponding time in the future. The warning device 30 may be a display or a sound device that provides images or sounds as warning signals.

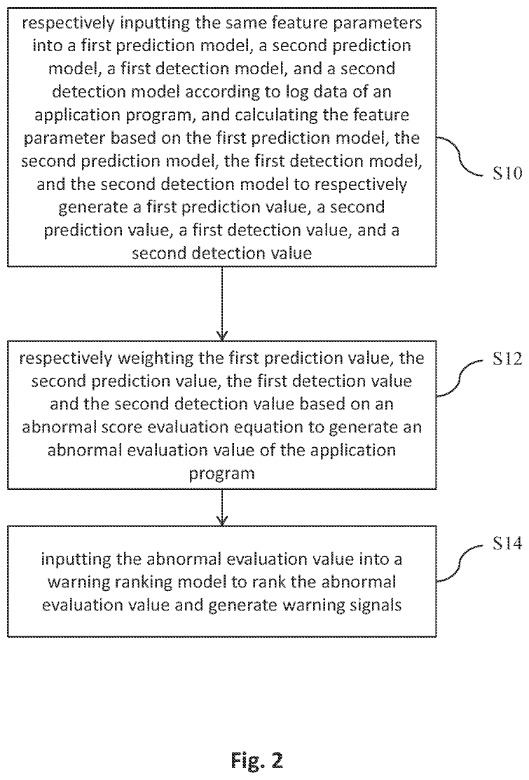

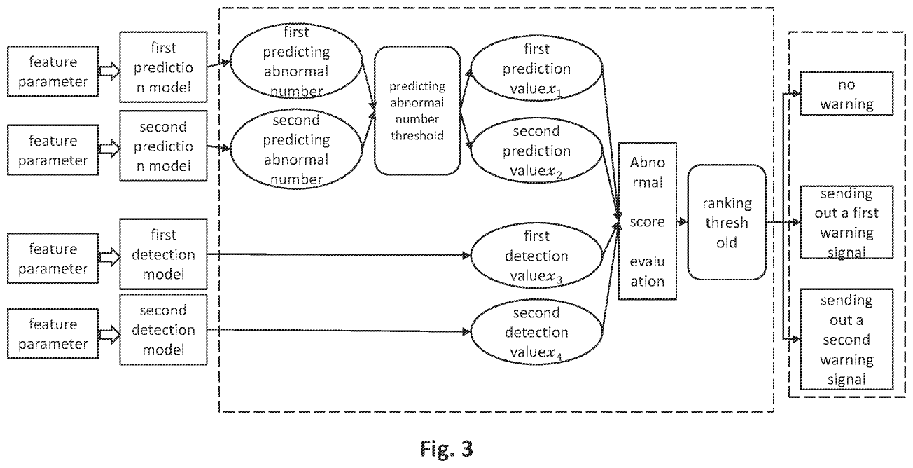

Then, a process where the processing device 20 predicts the abnormal occurrence of the application program according to the feature parameter is detailed as follows. In the embodiment, the processing device 20 includes a first prediction module 22, a second prediction module 24, a first detection module 26, a second detection module 27, an abnormal score evaluation module 28, and a warning ranking module 29. Referring to FIG. 2 and FIG. 3, the operation functions of the processing device 20 and each module and the method for detecting the abnormal occurrence of the application program are detailed as follows.

In Step S10, the processing device 20 receives feature parameters from the feature parameter collecting device 10 according to the log data of the application program. The processing device 20 respectively inputs the same feature parameters to the first prediction module 22, the second prediction module 24, the first detection module 26, and the second detection module 27. The first prediction module 22 calculates the feature parameter to generate a first prediction value. The first prediction value is the value of an abnormal occurrence after a period of time. For example, the first prediction value is the value of an abnormal occurrence 15 minutes later. The second prediction module 24 calculates the feature parameter to generate a second prediction value. The second prediction value is the value of an abnormal occurrence after a period of time. For example, the second prediction value is the value of an abnormal occurrence 15 minutes later. The first detection module 26 calculates the feature parameter to generate a first detection value. The second detection module 27 calculates the feature parameter to generate a second detection value.

Specifically, the first prediction module 22 includes a first prediction model. In the embodiment, the first prediction model is a long short-term memory (LSTM) model. The first prediction module 22 calculates the feature parameter to generate first predicting abnormal number based on the first prediction model. The first prediction module 22 compares the first predicting abnormal number with a predicting abnormal number threshold to generate a result, thereby generating the first prediction value.

The second prediction module 24 includes a second prediction model. In the embodiment, the second prediction model is a Poisson regression model. The second prediction module 24 calculates the feature parameter to generate second predicting abnormal number based on the second prediction model. The second prediction module 24 compares the second predicting abnormal number with the predicting abnormal number threshold to generate a result, thereby generating the second prediction value.

The foregoing result indicates whether the first predicting abnormal number or the second predicting abnormal number is within a range of the predicting abnormal number threshold. In the embodiment, the first prediction value and the second prediction value are represented by binary codes 0/1. Specifically, the range of the predicting abnormal number threshold compared with the first predicting abnormal number or the second predicting abnormal number is 2.5 standard deviations from the mean of the number of abnormal occurrences within a period of time in the past. For example, the period of time may be a week. When the first predicting abnormal number or the second predicting abnormal number is within the range of the predicting abnormal number threshold, the application program is normal and the first prediction value or the second prediction value is represented with 0. When the first predicting abnormal number or the second predicting abnormal number is not within the range of the predicting abnormal number threshold, the application program is abnormal and the first prediction value or the second prediction value is represented with 1.

The method of generating the first detection value is introduced as follows. The first detection value is a value detected over a period of time in the past, such as the value of the abnormal occurrence of the application program 15 minutes ago. The first detection module 26 includes a first detection model, such as a HC+Decision tree model. The first detection module 26 calculates the feature parameter based on the first detection model to generate the first detection value. In the embodiment, the first detection value is also represented with a binary code. When the abnormal occurrence is not detected, the first detection value is 1. When the abnormal occurrence is detected, the first detection value is 0.

The method of generating the second detection value is introduced as follows. The second detection value is a value detected over a period of time in the past, such as the value of the abnormal occurrence of the application program 15 minutes ago. The second detection module 27 includes a second detection model, such as an isolation forest (iForest) model. The second detection module 27 calculates the feature parameter based on the second detection model to generate the second detection value. In the embodiment, the second detection value is also represented with a binary code. When the abnormal occurrence is not detected, the second detection value is 1. When the abnormal occurrence is detected, the second detection value is 0.

After generating the first prediction value, the second prediction value, the first detection value, and the second detection value, the process proceeds to Step S12. In Step S12, the first prediction value, the second prediction value, the first detection value, and the second detection value are inputted to the abnormal score evaluation module 28. The abnormal score evaluation module 28 respectively weights the first prediction value, the second prediction value, the first detection value and the second detection value based on an abnormal score evaluation equation. In the embodiment, the initial value of a weighted value is set to 0.25. Besides, the weighted value of the first prediction value>the weighted value of the second prediction value>the weighted value of the first detection value>the weighted value of the second detection value. The abnormal score evaluation module 28 calculates the mean and sum of the weighted first prediction value, the weighted second prediction value, the weighted first detection value and the weighted second detection value to generate an abnormal evaluation value of the application program. The abnormal score evaluation equation is represented with Σᵢ₌₁ⁿwᵢxᵢ/n, n=the count of x, where xᵢ represents the first prediction value (x₁), the second prediction value (x₂), the first detection value (x₃) or the second detection value (x₄), and wᵢ represents the weighted value (w₁) of the first prediction value, the weighted value (w₂) of the second prediction value, the weighted value (w₃) of the first detection value or the weighted value (w₄) of the second detection value.

After generating the abnormal evaluation value, the process proceeds to Step S14. In Step S14, the abnormal evaluation value is inputted to the warning ranking model of the warning ranking module 29 for ranking the abnormal evaluation value. When the warning ranking module 29 determines that the abnormal evaluation value is less than or equal to a first ranking threshold, no warning is sent out. The warning ranking module 29 generates a first warning signal when the abnormal evaluation value is greater than the first ranking threshold and the abnormal evaluation value is less than or equal to a second ranking threshold. The warning ranking module 29 generates a second warning signal when the abnormal evaluation value is greater than the second ranking threshold. In the embodiment, the first ranking threshold is set to 0.33, and the second ranking threshold is set to 0.67.

After ranking warning signals, the warning device 30 sends out the first warning signal and the second warning signal. In the embodiment, the first warning signal is an email message sent to the administrator's mailbox to remind the administrator that there is a low risk that the application program is abnormal, and please check and repair it. The second warning signal includes an email message and a short message sent to the administrator's mailbox and communication device to remind the administrator that there is a high risk that the application program is abnormal, and please check and repair it.

In conclusion, the present invention can actively predict the abnormal trend of the application program for early detection and countermeasures, and distinguish different levels of warnings according to abnormal situations, so as to effectively remind the administrator of taking countermeasures.

The embodiments described above are only to exemplify the present invention but not to limit the scope of the present invention. Therefore, any equivalent modification or variation according to the shapes, structures, features, or spirit disclosed by the present invention is to be also included within the scope of the present invention.

What is claimed is:

1. A method for detecting an abnormal occurrence of an application program comprising:
collecting a feature parameter according to log data of at least one application program;
respectively inputting the feature parameter into a first prediction model, a second prediction model, a first detection model, and a second detection model, and calculating the feature parameter based on the first prediction model, the second prediction model, the first detection model, and the second detection model to respectively generate a first prediction value, a second prediction value, a first detection value, and a second detection value;
respectively weighting the first prediction value, the second prediction value, the first detection value and the second detection value based on an abnormal score evaluation equation to generate an abnormal evaluation value of the at least one application program; and
inputting the abnormal evaluation value into a warning ranking model to rank the abnormal evaluation value, wherein generating a first warning signal when the abnormal evaluation value is greater than a first ranking threshold and the abnormal evaluation value is less than or equal to a second ranking threshold, and generating a second warning signal when the abnormal evaluation value is greater than the second ranking threshold.

2. The method for detecting an abnormal occurrence of an application program according to claim 1, wherein the abnormal score evaluation equation is represented with
$$\frac{{\sum }_{i = 1}^{n} {w}_{i} {x}_{i}}{n} ,$$
n=the count of x, where xᵢ represents the first prediction value, the second prediction value, the first detection value or the second detection value, and wᵢ represents a weighted value of the first prediction value, the second prediction value, the first detection value or the second detection value.

3. The method for detecting an abnormal occurrence of an application program according to claim 1, wherein the step of respectively inputting the feature parameter into the first prediction model and the second prediction model and calculating the feature parameter based on the first prediction model, the second prediction model to respectively generate the first prediction value and the second prediction value comprises:
by the first prediction model and the second prediction model, receiving and calculating the feature parameter to respectively generate first predicting abnormal number and second predicting abnormal number; and
comparing the first predicting abnormal number and the second predicting abnormal number with a predicting abnormal number threshold to generate results, thereby generating the first prediction value and the second prediction value.

4. The method for detecting an abnormal occurrence of an application program according to claim 3, wherein the result indicates whether the first predicting abnormal number or the second predicting abnormal number is within a range of the predicting abnormal number threshold.

5. The method for detecting an abnormal occurrence of an application program according to claim 1, wherein the first prediction model is a long short-term memory (LSTM) model.

6. The method for detecting an abnormal occurrence of an application program according to claim 1, wherein the second prediction model is a Poisson regression model.

7. The method for detecting an abnormal occurrence of an application program according to claim 1, wherein the first detection model is a HC+Decision tree model.

8. The method for detecting an abnormal occurrence of an application program according to claim 1, wherein the second detection model is an isolation forest (iForest) model.

9. The method for detecting an abnormal occurrence of an application program according to claim 1, wherein the feature parameter includes time information and number of abnormal occurrences corresponding to the time information.

10. A system for detecting an abnormal occurrence of an application program comprising:
a feature parameter collecting device configured to collect a feature parameter according to log data of at least one application program;
a processing device coupled to the feature parameter collecting device and configured to receive the feature parameter, wherein the processing device comprises:
a first prediction module configured to receive and calculate the feature parameter to generate a first prediction value;
a second prediction module configured to receive and calculate the feature parameter to generate a second prediction value;
a first detection module configured to receive and calculate the feature parameter to generate a first detection value;
a second detection module configured to receive and calculate the feature parameter to generate a second detection value;
an abnormal score evaluation module configured to respectively weight the first prediction value, the second prediction value, the first detection value and the second detection value based on an abnormal score evaluation equation to generate an abnormal evaluation value of the at least one application program; and
a warning ranking module configured to receive and rank the abnormal evaluation value, wherein the warning ranking module generates a first warning signal when the abnormal evaluation value is greater than a first ranking threshold and the abnormal evaluation value is less than or equal to a second ranking threshold, and the warning ranking module generates a second warning signal when the abnormal evaluation value is greater than the second ranking threshold; and
a warning device coupled to the processing device and configured to receive and send out the first warning signal and the second warning signal.

11. The system for detecting an abnormal occurrence of an application program according to claim 10, wherein the abnormal score evaluation equation is represented with
$$\frac{{\sum }_{i = 1}^{n} {w}_{i} {x}_{i}}{n} ,$$
n=the count of x, where xᵢ represents the first prediction value, the second prediction value, the first detection value or the second detection value, and wᵢ represents a weighted value of the first prediction value, the second prediction value, the first detection value or the second detection value.

12. The system for detecting an abnormal occurrence of an application program according to claim 10, wherein the first prediction module includes a first prediction model and the second prediction module includes a second prediction model, the first prediction module and the second prediction module respectively calculate the feature parameter to generate first predicting abnormal number and second predicting abnormal number based on the first prediction model and the second prediction model, the first prediction module and the second prediction module respectively compare the first predicting abnormal number and the second predicting abnormal number with a predicting abnormal number threshold to generate results, thereby generating the first prediction value and the second prediction value.

13. The system for detecting an abnormal occurrence of an application program according to claim 12, wherein the result indicates whether the first predicting abnormal number or the second predicting abnormal number is within a range of the predicting abnormal number threshold.

14. The system for detecting an abnormal occurrence of an application program according to claim 12, wherein the first prediction model is a long short-term memory (LSTM) model.

15. The system for detecting an abnormal occurrence of an application program according to claim 12, wherein the second prediction model is a Poisson regression model.

16. The system for detecting an abnormal occurrence of an application program according to claim 10, wherein the first detection module includes a first detection model for calculating the feature parameter to generate the first detection value, and the first detection model is a HC+Decision tree model.

17. The system for detecting an abnormal occurrence of an application program according to claim 10, wherein the second detection module includes a second detection model for calculating the feature parameter to generate the second detection value, and the second detection model is an isolation forest (iForest) model.

18. The system for detecting an abnormal occurrence of an application program according to claim 10, wherein the feature parameter includes time information and number of abnormal occurrences corresponding to the time information.
